(19) United States
(12) Patent Application Publication
(10) Pub. No.: US 2007/0051419 A1
(43) Pub. Date: Mar. 8, 2007

(54) Duct

(76) Inventor: Phillip Michael Walsh, Darwen (GB)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/491,433

(22) Filed: Jul. 21, 2006

(30) Foreign Application Priority Data
Jul. 29, 2005 (GB) 0515587.4

(51) Int. Cl. F16L 9/00

(52) U.S. Cl. 138/157

(57) ABSTRACT

The invention is concerned with ducting for mounting upon elongate members such as cables, tubes etc and particularly for such members which are deployed under water. A duct constructed in accordance with the invention has an internal service 14 defining an elongate internal chamber for receiving the elongate member. Means are provided, such as tension bands 21, for applying tension around the duct to urge it toward the elongate member within. The duct is characterised by provision of internal spaces such as fins 30 which are interposed in use between the internal surface 14 of the duct and the external surface of the elongate member. The spaces are resiliently deformable and so are able to embrace elongate members having a range of different lateral dimensions.

### CROSS-REFERENCE TO RELATED APPLICATIONS

The present patent application claims priority from United Kingdom Patent Application No. 0515587.4, filed on Jul. 9, 2005.

### BACKGROUND OF THE INVENTION

The present invention relates to ducts for mounting upon elongate members, particularly but not exclusively those which are deployed underwater. Such members include cables, which may be electric, fibre optic or of other types, and tubular members such as the risers used in hydrocarbon extraction, or pipelines used to convey hydrocarbons.

There is often a need to protect such members from physical damage. Where the entire length of the member requires protection it is typically appropriate to apply some form of armouring to it during manufacture but an alternative, which is particularly appropriate where the member requires only localised protection, is to place protective ducting around the member. A commercially successful example of such ducting is illustrated and described in CRP Group Ltd.'s British patent GB2276694 and consists of a set of elongate, semi-cylindrical elastomer mouldings which can be assembled one against another to form a cylindrical hollow duct around the member being protected. Straps are drawn tightly around the ducting to secure it in place. It is necessary to resist slippage of the duct along the member. For instance where the member in question is to be used underwater, the process of deployment typically involves feeding the member out from a vessel. Forces applied to the ducting must be transferred to the member within if the process is to be controlled. To achieve this, the known ducting has an internal diameter chosen to provide only a small clearance from the member within. For instance where the member is a cable having a diameter of a few centimetres, the internal diameter of the ducting is typically 2 millimetres greater than the O/D of the member. When the straps are tightened, this clearance is taken up; the ducting is forced against the member and grips it.

While proven and effective, this approach has some disadvantages. The need to closely match the ducting's dimensions to those of the elongate member is inconvenient for the manufacturer and distributor, who must either offer a range of sizes to suit all applications or manufacture the ducting on a bespoke basis. Where the elongate member is of large diameter (marine risers can be in excess of 50 centimetres across) their manufacturing tolerance can be so large that the ducting must be made to match the “as built” diameter of the member, which means manufacture of the ducting cannot begin until the member has been made and measured.

### SUMMARY OF THE INVENTION

In accordance with the present invention, there is a duct to be placed around an elongate member, the duct having an internal surface defining an elongate internal chamber for receiving the elongate member and being provided with means, at intervals along its length, for applying tension to urge the duct toward the elongate member within, the duct being characterised by provision of internal spacers interposed in use between the internal surface and the elongate member, the spacers being resiliently deformable and so able to embrace elongate members having a range of lateral dimensions.

Of course the elongate member in question, be it a cable or bundle of cables, or a pipe, riser etc., will often be of circular section. Correspondingly the duct may be substantially annular in section.

The internal spacers may be formed as fins which extend circumferentially about the internal surface, although in principle any of a wide range of shapes would be suitable. The internal spacers are preferably formed as protrusions from the internal surface.

In a particularly preferred embodiment, the duct defines a longitudinal axis and the protrusions have an outermost root and an innermost contact surface for making contact with the elongate member, the shape of the protrusion being such that pressure applied to the contact surface by contact with the elongate member displaces the contact surface axially relative to the root as well as outwardly. Hence the protrusions are bent back, rather than simply being compressed, and their range of movement is thereby increased. To achieve this the protrusions may be formed such that they have no radial plane of symmetry. A saw tooth shape, in longitudinal section, is suitable.

Preferably each protrusion is shaped to resist longitudinal slippage of the duct along the elongate member in a particular direction. In such an embodiment resistance to slippage in both directions can be provided using protrusions having two different shapes which are thus adapted to resist longitudinal slippage of the duct in opposite directions. The two different shapes may be mirror images of one another.

The protrusions are preferably arranged in sets, with longitudinal spaces between the sets. The means for applying tension are preferably disposed around respective sets of protrusions.

It is particularly preferred that the duct comprises multiple moulded ducting components assembled to each other. One advantage is that the duct can be assembled in situ upon the elongate member. The ducting components may have a substantially semi-annular cross section, and mating faces through which they contact a radially neighbouring component.

Preferably the ducting components are formed of an elastomer.

Preferably the means for applying tension comprise tension straps extending around the duct.

In accordance with a second aspect of the present invention, there is a ducting component having a concave inner surface for receiving an elongate member and a convex outer surface, the ducting component being shaped such that it can be drawn against the elongate member by means of tension straps, and being characterised by provision of protrusions from its inner surface which cause the inner surface to stand off from the resilient member in use and are resiliently deformable and so able to embrace elongate members having a range of lateral dimensions.

### BRIEF DESCRIPTION OF THE DRAWINGS

A specific embodiment of the present invention will now be described, by way of example only, with reference to the accompanying drawings, in which:

FIG. 1 is an elevation of a ducting component embodying the present invention;

FIG. 2 is a side elevation of the same component;

FIG. 3 is a section through part of the same component, in a plane perpendicular to the lines A-A of FIG. 1;

FIG. 4 is an end view of the same component, along the direction indicated by arrow B in FIG. 2; and

FIGS. 5 and 6 are perspective views of the same component, showing opposite sides of it.

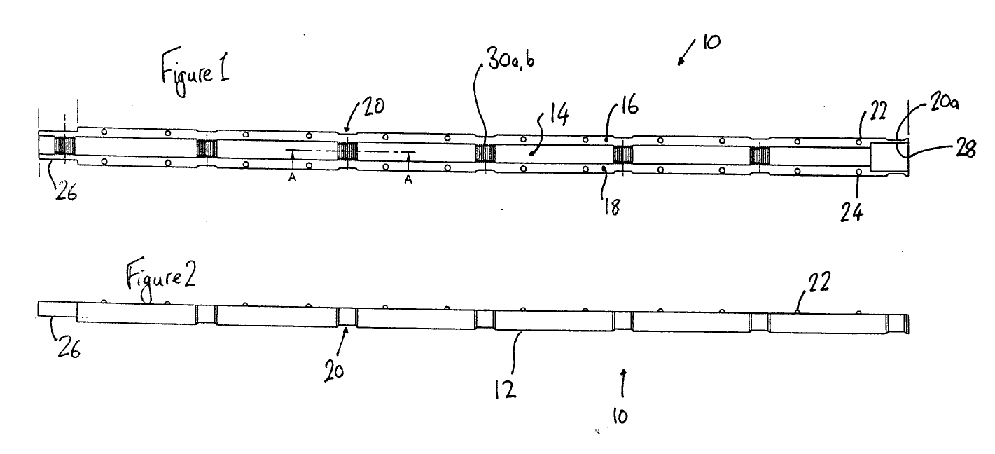

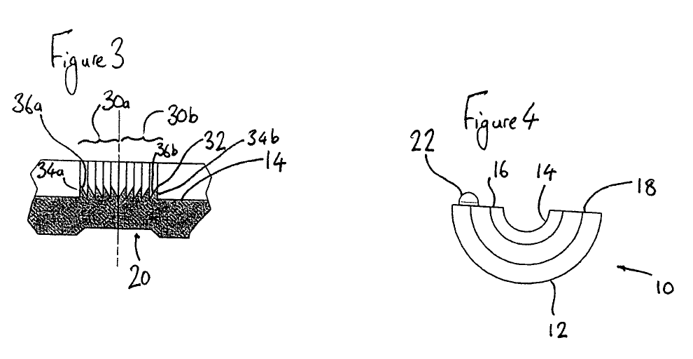

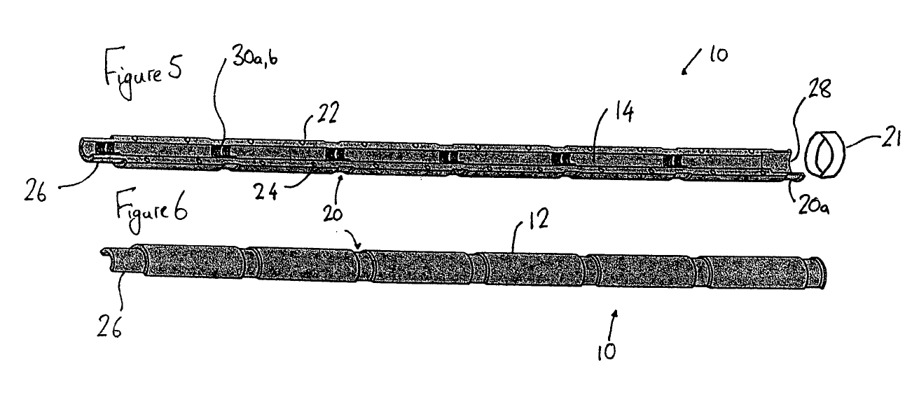

### DETAILED DESCRIPTION OF THE INVENTION

The illustrated ducting component 10 is a unitary moulding formed of elastomeric material. The preferred material for underwater applications is polyurethane. The component is semi-annular in cross section, having a convex semi-circular outer face 12 and a concave semi-circular inner face 14, which are bridged by mating faces 16, 18 lying in a common plane containing the duct's axis. It will be apparent that two such components can be assembled together, with their mating faces in contact, to form a duct of annular cross section having a cylindrical interior space for receiving the elongate member. Circumferential recesses 20 formed in the exterior of the ducting receive respective tension bands 21 to secure the ducting components to each other. Alignment of the recesses in radially neighbouring components is ensured by pips 22 projecting from one of the mating faces 16 for receipt in corresponding depressions 24 in the other mating face 18. Axially neighbouring components in a length of ducting engage with each other through a male/female arrangement comprising a spigot 26 formed as a reduced external diameter portion at one end of the component which is received in a socket 28 formed by an increased internal diameter portion at the other end. The socket is surrounded by a recess 20a so that a tension band can be placed around the spigot/socket junction. This junction need not however bear a large axial load, since the junctions on either side of the plane formed by the mating faces 16, 18 can be staggered. That is, the ends of one component can be misaligned from the ends of the radially neighbouring component. Note that an entire duct can be constructed from a set of identical ducting components 10.

In accordance with the present invention, the ducting component is provided with radially inwardly directed fins 30a,b which protrude from its inner face 14. These cause the inner face 14 to stand off from the outer surface of the elongate member, and it is through the fins 30 that the ducting grips the member. The fins 30 are able to resiliently deform when forced against the member and so to embrace and grip members having a range of external diameters. In the present embodiment, the fins 30 extend around the duct's internal circumference. The fins are arranged in sets, side-by-side with and adjacent to each other, and sets of fins are longitudinally separated. Each set of fins is within a respective recess 20 and so is within a tension band 21 in the assembled duct, so that the band directly applies a radial force to urge the fins against the elongate member within. The fins are formed such that when they are deformed by contact with the elongate member, their contact surfaces—formed in the present embodiment by their tips 32—are displaced relative to the fin's root not only radially but also axially. In the illustrated embodiment this happens because the fins are asymmetric about a radial plane. More specifically, each fin has one flank 34a,b which lies in a radial plane and another flank 36a,b which is inclined to the same plane, so that each fin has the shape of a saw tooth. There are two types of fin, one being the mirror image of the other. Fins 30a are shaped such that their tips 32 are displaced to the left (as viewed) when forced radially outwards. The tips of fins 30b are displaced to the right. Slippage of the duct toward the left is resisted particularly by the fins 30a, since movement in this direction tends to tighten their grip upon the elongate member. Slippage toward the right is resisted by the fins 30b in a similar manner. It will be apparent that the function of the fins could be performed by protrusions having other shapes. Numerous other possible variations will present themselves to the skilled person. For example the ducting components could be in the form of a split tube, rather than being semi-annular, the tube being able to open out to receive the elongate member.

What is claimed:

1. A duct to be placed around an elongate member, the duct having an internal surface defining an elongate internal chamber for receiving the elongate member and being provided with means, at intervals along its length, for applying tension to urge the duct toward the elongate member within, the duct being characterised by provision of internal spacers interposed in use between the internal surface and the elongate member, the spacers being resiliently deformable and so able to embrace elongate members having a range of lateral dimensions.

2. A duct as claimed in claim 1 which is substantially annular in section.

3. A duct as claimed in claim 2 in which the internal spacers are formed as fins which extend circumferentially about the internal surface.

4. A duct as claimed in claim 1 in which the internal spacers are formed as protrusions from the internal surface.

5. A duct as claimed in claim 4 in which the duct defines a longitudinal axis and the protrusions have an outermost root and an innermost contact surface for making contact with the elongate member, the shape of the protrusion being such that pressure applied to the contact surface by contact with the elongate member displaces the contact surface axially relative to the root as well as outwardly.

6. A duct as claimed in claim 5 in which the duct is substantially annular in section and the protrusions have no radial plane of symmetry.

7. A duct as claimed in claim 5 in which the protrusions collectively have a saw tooth shape in longitudinal section.

8. A duct as claimed in claim 1, wherein each protrusion is shaped to resist longitudinal slippage of the duct along the elongate member in a particular direction.

9. A duct as claimed in claim 8 comprising protrusions having two different shapes which are thus adapted to resist longitudinal slippage of the duct in opposite directions.

10. A duct as claimed in claim 9 wherein the two different shapes are mirror images of one another.

11. A duct as claimed in claim 4 wherein the protrusions are arranged in sets, with longitudinal spaces between the sets.

12. A duct as claimed in claim 11 wherein the means for applying tension are disposed around respective sets of protrusions.

13. A duct as claimed in claim 1 which comprises multiple unitary moulded ducting components assembled to each other.

14. A duct as claimed in claim 13 wherein the ducting components have a substantially semi-annular cross section, and mating faces through which they contact a radially neighbouring component.

15. A duct as claimed in claim 13 wherein the spacers are each an integral part of a ducting component.

16. A duct as claimed in claim 13 wherein the ducting components are formed of an elastomer.

17. A duct as claimed in claim 1 wherein the means for applying tension comprise tension straps extending around the duct.

18. A duct as claimed in claim 1 which is for underwater deployment.

19. A ducting component having a concave inner surface for receiving an elongate member and a convex outer surface, the ducting component being shaped such that it can be drawn against the elongate member by means of tension straps, and being characterised by provision of protrusions from its inner surface which cause the inner surface to stand off from the resilient member in use and are resiliently deformable and so able to embrace elongate members having a range of lateral dimensions.

20. A ducting component as claimed in claim 19 which is substantially annular in section.

21. A ducting component as claimed in claim 19 in which the inner surface is circular or part circular and the protrusions are formed as fins which extend circumferentially about the internal surface.

22. A ducting component as claimed in claim 19 having a longitudinal axis, the protrusions having an outermost root and an innermost contact surface for making contact with the elongate member, the shape of the protrusion being such that pressure applied to the contact surface by contact with the elongate member displaces the contact surface axially relative to the root as well as outwardly.

23. A ducting component as claimed in claim 22 in which the inner surface is circular or part-circular and the protrusions have no radial plane of symmetry.

24. A ducting component as claimed in claim 19 in which the protrusions have a saw tooth shape in longitudinal section.

25. A duct as claimed in claim 19 in which each protrusion is shaped to resist longitudinal slippage of the duct along the elongate member in a particular direction.

26. A ducting component as claimed in claim 25 comprising protrusions having two different shapes which are thus adapted to resist longitudinal slippage of the duct in opposite directions.

27. A ducting component as claimed in claim 26 in which the two different shapes are mirror images of one another.

28. A ducting component as claimed in claim 19 in which the protrusions are arranged in sets, with longitudinal spaces between the sets.

29. A ducting component as claimed in claim 28 which is shaped to receive and locate the tension straps at positions around respective sets of protrusions.

30. A ducting component as claimed in claim 29 which has circumferential depressions in its outer surface to receive and locate the tension straps.

31. A ducting component as claimed in claim 19 which is shaped to engage with other identically formed components so that a duct can be built up from multiple such components.

32. A ducting component as claimed in claim 31 which is semi-annular in cross section and is shaped such that when placed against a radially neighbouring component it forms an annular duct with an internal chamber for receiving the elongate member.

33. A ducting component as claimed in claim 31 which has male and female coupling features at opposite ends to engage with longitudinally neighbouring ducting components of similar type.

34. A ducting component as claimed in claim 19 which is formed of an elastomer.
